(19) United States
(12) Patent Application Publication
(10) Pub. No.: US 2022/0238894 A1
(43) Pub. Date: Jul. 28, 2022

(54) FUEL CELL

(71) Applicant: FTXT ENERGY TECHNOLOGY CO., LTD., Shanghai (CN)

(72) Inventor: Ke JIN, Shanghai (CN)

(73) Assignee: FTXT ENERGY TECHNOLOGY CO., LTD., Shanghai (CN)

(21) Appl. No.: 17/720,833

(22) Filed: Apr. 14, 2022

Related U.S. Application Data
(63) Continuation of application No. PCT/CN2019/111465, filed on Oct. 16, 2019.

(51) Int. Cl. H01M 8/04029; H01M 8/2465

(52) U.S. Cl. CPC H01M 8/04029; H01M 8/2465

(57) ABSTRACT

A fuel cell includes at least two single cells stacked adjacent to each other. A cathode plate (1) of one single cell is stacked adjacent to an anode plate (2) of an adjacent single cell. The cathode plate (1) includes a cathode plate body (11), the cathode plate body (11) has a cathode channel ridge (12) protruding towards the anode plate (2), and the cathode channel ridge (12) has a cathode channel (121) formed therein. The anode plate (2) includes an anode plate body (21), the anode plate body (21) has an anode channel ridge (22) protruding towards the cathode plate (1), and the anode channel ridge (22) has an anode channel (221) formed therein. A cooling channel (3) is formed between the cathode plate (1) and the anode plate (2). The anode channel ridge (22) and the cathode channel ridge (12) are intersected with each other.

### FIELD

The present disclosure relates to the field of electrochemical cells, and more particularly, to a fuel cell.

### BACKGROUND

Fuel cells produce electricity by reacting hydrogen with oxygen in the air, and the product of the reaction is water. Without being limited by the Carnot cycle, the efficiency may reach more than 50%. Therefore, the fuel cells are not only environmentally friendly but also energy-saving. A bipolar plate fuel cell includes a cathode plate and an anode plate. The cathode plate has cathode channels formed on a side thereof, and an oxidizing gas (e.g., oxygen) is suitable to flow in the cathode channels. The anode plate has anode channels formed on a side thereof, and a reducing gas (e.g., hydrogen) is suitable to flow in the anode channels. Cooling channels are formed between the cathode plate and the anode plate and are provided to allow the cooling liquid to flow therein. The cathode plate and the anode plate are important components of the bipolar plate fuel cell, having the functions of supporting the fuel cell, providing reaction gas, and cooling the channels.

The fuel cell has wide application in the fields such as automobiles, airplanes and the like, which set higher requirements on a power density of the fuel cell. In the technical routes for improving the power density of the fuel cell, it has remarkable effects to reduce the thickness of the cathode plate and the anode plate.

Considering the processing convenience of the conventional fuel cell, the cathode channels, the anode channels, and the cooling channels are all disposed in parallel, for example, as disclosed in German Patent DE102013208450A1. Thus, it is required to distribute three fluids in fluid distribution transition regions at the two ends of the channels, resulting a concentration of complexity of the fluid distribution transition regions. This concentration of complexity is not a significant problem in the conventional bipolar plate structures having a thickness about 1 mm. However, when the thickness is reduced to be smaller than or equal to 0.6 mm, the fluid distribution transition region will become a bottleneck for increasing the single cell scale. A single cell current of the existing fuel cells, which have thin bipolar plates (for example, with a thickness of only 0.6 mm), can hardly reach 600A, failing to meet the application requirements of ultrahigh power in the fields such as automobiles, airplanes.

### SUMMARY

In view of the above, the present disclosure provides a fuel cell to reduce the complexity of a fluid distribution transition region.

In order to achieve the purpose, the technical solution of the present disclosure is realized as follows.

A fuel cell includes at least two single cells stacked adjacent to each other. A cathode plate of one of the at least two single cells is stacked adjacent to an anode plate of an adjacent single cell. The cathode plate includes a cathode plate body, the cathode plate body has a cathode channel ridge disposed thereon and protruding towards the anode plate, and the cathode channel ridge has a cathode channel formed therein. The anode plate includes an anode plate body, the anode plate body has an anode channel ridge disposed thereon and protruding towards the cathode plate, and the anode channel ridge has an anode channel formed therein. A cooling channel is formed between the cathode plate and the anode plate. The anode channel ridge and the cathode channel ridge are intersected with each other, and an included angle between the anode channel ridge and the cathode channel ridge ranges from 60° to 120°.

According to some embodiments of the present disclosure, the anode channel ridge is arranged perpendicular to the cathode channel ridge.

According to some embodiments of the present disclosure, a recess is formed at an intersection between the anode channel ridge and the cathode channel ridge, the anode channel ridge is fitted in the recess, the recess is located on a flow path of the cathode channel and is recessed towards an inside of the cathode channel, and a channel depth of the cathode channel at the recess is smaller than a channel depth of the cathode channel at a position other than the recess.

Furthermore, the channel depth of the cathode channel at the recess is 0.2 mm, and the channel depth of the cathode channel at a position other than the recess is 0.4 mm.

According to some embodiments of the present disclosure, a plurality of anode channel ridges is provided, and the plurality of anode channel ridges is arranged in parallel and spaced apart from each other; and a plurality of cathode channel ridges is provided, and the plurality of cathode channel ridges is arranged in parallel and spaced apart from each other.

According to some embodiments of the present disclosure, the anode channel ridge has a plurality of sub-channel ridges, each of the plurality of sub-channel ridges has a sub-channel formed therein and in communication with the anode channel, and each of the plurality of sub-channel ridges is parallel to the cathode channel ridge.

Further, the plurality of sub-channel ridges of one of the plurality of anode channel ridges is arranged alternately with the plurality of sub-channel ridges of an adjacent anode channel ridge.

Further, the plurality of sub-channel ridges is located between two adjacent cathode channel ridges.

Further, the plurality of sub-channel ridge is spaced apart from the cathode plate body and in communication with the cooling channel; and the plurality of cathode channel ridge is attached to the anode plate body.

Further, the cathode plate is an oxygen-side plate, and the anode plate is a hydrogen-side plate.

Compared with the related art, the fuel cell has the following advantages.

For the fuel cell of the present disclosure, the anode channel ridge and the cathode channel ridge are intersected with each other, which is conducive to reducing a complexity of a fluid distribution transition regions and thus is conducive to reducing the thicknesses of the cathode plate and the anode plate, thereby increasing a power density and a maximum discharge current of the fuel cell.

### BRIEF DESCRIPTION OF DRAWINGS

The accompanying drawings, as a part of the present disclosure, are provided to facilitate the understanding of the present disclosure. The exemplary embodiments of the present disclosure together with the description thereof serve to explain the present disclosure and do not constitute limitations of the present disclosure. In the drawings:

FIG. 1 is a schematic diagram illustrating a cathode plate and an anode plate that are stacked;

FIG. 2 is a schematic diagram of a side of an anode plate facing towards the cooling channels;

FIG. 3 is a schematic diagram of a side of a cathode plate facing towards a membrane electrode (MEA);

FIG. 4 is an enlarged view of C portion in FIG. 1;

FIG. 5 is a cross-sectional view of FIG. 4 along A-A;

FIG. 6 is a cross-sectional view of FIG. 4 along A′-A′;

FIG. 7 is a cross-sectional view of FIG. 1 along B-B;

FIG. 8 is an enlarged view of portion D in FIG. 6; and

FIG. 9 is a schematic layout of a cathode channel, an anode channel, and a cooling channel.

### Reference Symbols

cathode plate 1, cathode plate body 11, cathode channel ridge 12, cathode channel 121, recess 122, anode plate 2, anode plate body 21, anode channel ridge 22, anode channel 221, sub-channel ridge 23, sub-channel 231, cooling channel 3, hydrogen inlet manifold chamber 20, hydrogen outlet manifold chamber 30, oxygen inlet manifold chamber 40, oxygen outlet manifold chamber 50, reaction region 60 and transition region 70.

### DESCRIPTION OF EMBODIMENTS

It should be noted that embodiments of the present disclosure and features of the embodiments may be combined with each other, unless they are contradictory to each other.

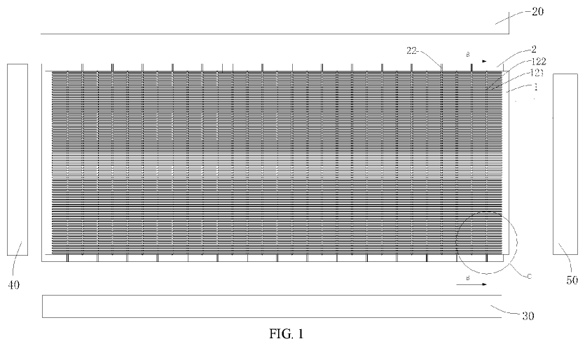

The present disclosure will be described in detail below with reference to FIGS. 1 to 9 in conjunction with embodiments.

Referring to FIG. 1 to FIG. 3 and FIG. 7, a fuel cell according to an embodiment of the present disclosure includes at least two single cells that are stacked adjacent to each other. A cathode plate 1 of one single cell is stacked adjacent to an anode plate 2 of an adjacent single cell.

The cathode plate 1 includes a cathode plate body 11. The cathode plate body 11 has cathode channel ridges 12 disposed thereon and protruding towards the anode plate 2. The cathode channel ridge 12 has a cathode channel 121 formed therein, and an oxidizing gas flows in the cathode channel 121. The oxidizing gas may be air, and the oxygen in the air participates in an electrochemical reaction in the fuel cell.

The anode plate 2 includes an anode plate body 21. The anode plate body 21 has anode channel ridges 22 disposed thereon and protruding towards the cathode plate 1. The anode channel ridge 22 has an anode channel 221 formed therein, and a reducing gas flows in the anode channel 221. The reducing gas may be hydrogen.

Cooling channels 3 are formed between the cathode plate 1 and the anode plate 2.

Specifically, the cooling channel 3 is formed at a position where the cathode plate 1 and the anode plate 2 are not attached to each other, and a cooling liquid or a cooling agent flows in the cooling channels 3.

At two ends of the cathode channel 121, the anode channel 221 and the cooling channel 3, it is necessary to provide fluid distribution transition regions to distribute the oxidizing gas, the reducing gas, and the cooling liquid.

The anode channel ridge 22 and the cathode channel ridge 12 are intersected with each other, and an included angle between the anode channel ridge 22 and the cathode channel ridge 12 ranges from 60° to 120°. In this way, the fluid distribution transition region for the cathode channels 121 and the fluid distribution transition region for the anode channels 221 can be arranged separately, i.e., a hydrogen inlet manifold chamber 20, a hydrogen outlet manifold chamber 30, an oxygen inlet manifold chamber 40, and an oxygen outlet manifold chamber 50, as illustrated in FIG. 1, which is beneficial to reducing the complexity of the fluid distribution transition regions. Therefore, it is conducive to overcoming the problem that the fluid distribution transition regions can be hardly arranged when the scale of single cells is enlarged by using the ultrathin cathode plates 1 and the ultrathin anode plates 2, thereby advantageously improving the power density of the fuel cell.

According to the fuel cell of the present disclosure, since the anode channel ridge 22 and the cathode channel ridge 12 are intersected with each other, the complexity of the fluid distribution transition regions can be advantageously reduced, and further, the thicknesses of the cathode plate 1 and the anode plate 2 can be advantageously reduced, so as to achieve the purpose of increasing the power density and the maximum discharge current of the fuel cell.

Referring to FIG. 1, the anode channel ridge 22 is arranged to be perpendicular to the cathode channel ridge 12, to maximize a distance between the fluid distribution transition region for the cathode channels 121 and the fluid distribution transition region for the anode channel 221. Therefore, the thicknesses of the cathode plate 1 and the anode plate 2 can be further reduced, thereby improving the power density of the fuel cell and maximum discharge current of the fuel cell.

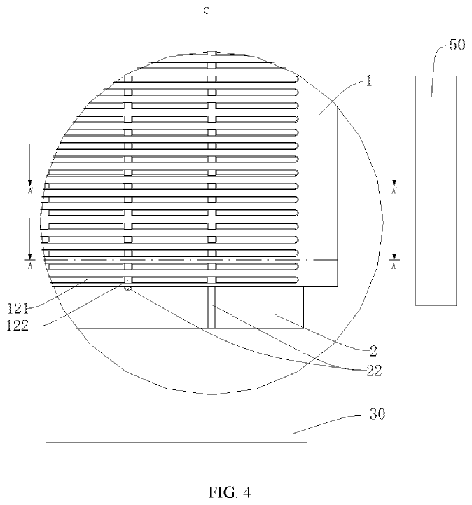

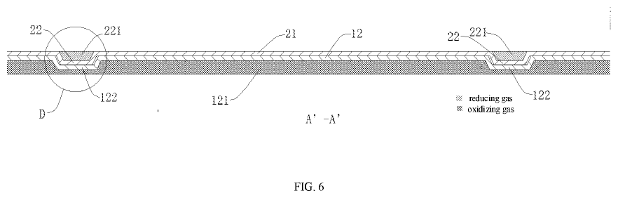

Referring to FIG. 4, FIG. 6, and FIG. 8, a recess 122 is formed at an intersection between the anode channel ridge 22 and the cathode channel ridge 12. The anode channel ridge 22 is fitted in the recess 122. The recess 122 is located on a flow path of the cathode channel 121 and is recessed towards an inside of the cathode channel 121. A channel depth e of the cathode channel 121 at the recess 122 is smaller than a channel depth f of the cathode channel 121 at a position other than the recess 122.

Specifically, a plurality of recesses 122 recessed towards the inside of the cathode channel 121 is disposed on the cathode channel ridge 12 along the flowing direction of the oxidizing gas. The positions and the number of the recesses 122 correspond to the positions and the number of the intersections between the anode channel ridge 22 and the cathode channel ridge 12, such that the recesses 122 on the cathode channel ridge 12 are engaged with the anode channel ridge 22, thereby facilitating an assembly of the cathode plate 1 and the anode plate 2, and ensuring the correct positioning between the cathode plate 1 and the anode plate 2.

The recesses 122 may slightly increase a gas resistance of the cathode channel 121. However, the number of the channels of the anode plate 2 is smaller, and the depth thereof is shallower, that is, the number of the recesses 122 on each cathode channel 121 is smaller, and thus the increase of the gas resistance is not significant. Meanwhile, when the oxidizing gas flows through the recesses 122, turbulence may be generated, which is favorable for promoting mass transfer exchange.

Further, referring to FIG. 8, in some embodiments of the present disclosure, the channel depth e of the cathode channel 121 at the recess 122 is 0.2 mm, the channel depth f of the cathode channel 121 at a position other than the recess 122 is 0.4 mm. A thickness g of the cathode plate 1 before molding is 0.1 mm, and a thickness h of the anode plate 2 before molding is 0.1 mm. A depth i of the anode channel 221 is 0.2 mm, that is, a total thickness of the cathode plate 1 and the anode plate 2 that are assembled is 0.6 mm, which is beneficial to improving the power density of the fuel cell. The single cell current may reach 10000A, which can meet an application requirement of ultra-high power.

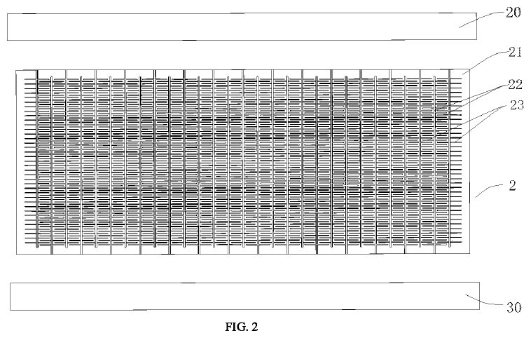

Referring to FIG. 2, a plurality of anode channel ridges 22 is provided. The plurality of anode channel ridges 22 is arranged in parallel and spaced apart from each other, which is beneficial to ensuring a uniform distribution of the hydrogen in the anode channel 221 to the maximal extent and timely discharging anode products.

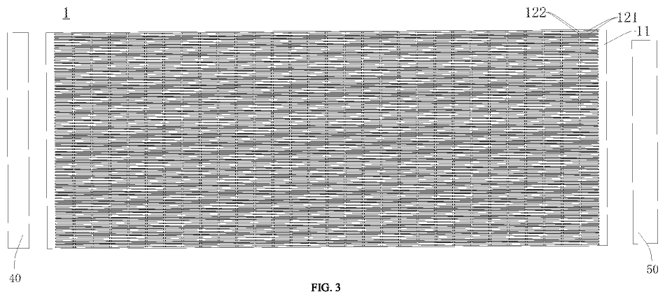

Referring to FIG. 3, a plurality of cathode channel ridges 12 is provided. The plurality of cathode channel ridges 12 is arranged in parallel and spaced apart from each other in parallel, which is beneficial to ensuring a uniform distribution of the air in the cathode channel 121 to the maximal extent and discharging the cathode product in time.

Referring to FIG. 2, the anode channel ridge 22 has a plurality of sub-channel ridges 23. Each sub-channel ridge 23 has a sub-channel 231 formed therein and in communication with the anode channel 221, and each sub-channel ridge 23 is parallel to the cathode channel ridge 12.

Further, the sub-channel ridges 23 of one anode channel ridge 22 are arranged alternately with the sub-channel ridges 23 of the adjacent anode channel ridge 22.

Further, the sub-channel ridges 23 are located between two adjacent cathode channel ridges 12.

That is, an anode flow field is an interdigitated flow field overlapping a two-level fractal interdigitated flow field, generated by the anode channel 221 and the sub-channel 231. Specifically, as illustrated in FIG. 2, the interdigitated flow field is generated by the plurality of anode channels 221, the two-level fractal interdigitated flow field is generated by the sub-channels 231 of the anode channels 221. As illustrated in FIG. 1, the sub-channel ridges 23 are located between two adjacent cathode channel ridges 12 to ensure sufficient supply of oxygen at high current density, thereby ensuring the performance of the fuel cell.

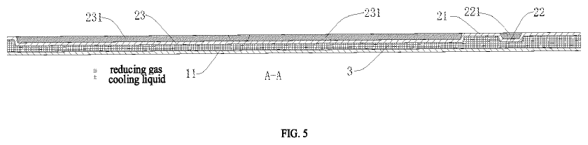

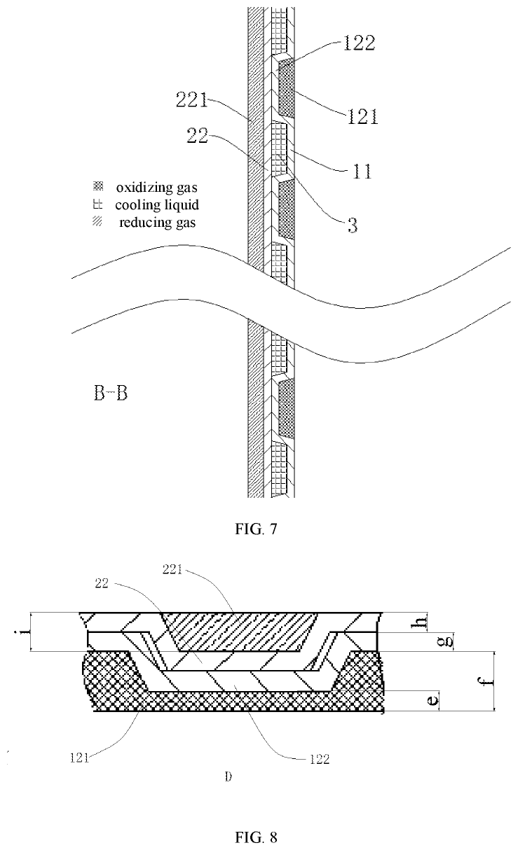

In some embodiments of the present disclosure, as illustrated in FIG. 5, the sub-channel ridges 23 are spaced apart from the cathode plate body 11 and in communication with the cooling channels 3. As illustrated in FIG. 6, the cathode channel ridges 12 are attached to the anode plate body 21. As illustrated in FIG. 7, the cooling channels 3 are formed between the cathode plate body 11 and the anode plate body 21 and located between two adjacent cathode channel ridges 12, and the cooling liquid flows in the cooling channels 3.

In some embodiments of the present disclosure, the cathode plate 1 is an oxygen-side plate, and the anode plate 2 is a hydrogen-side plate.

Referring to FIG. 1 and FIG. 3 to FIG. 4, the cathode plate 1 has an oxygen inlet manifold chamber 40 at one end and an oxygen outlet manifold chamber 50 at the other end. Oxygen enters the cathode channels 121 via the oxygen inlet manifold chamber 40, and the excess oxygen flows out of the cathode channels 121 and enters the oxygen outlet manifold chamber 50. Referring to FIG. 1 to FIG. 2 and FIG. 4, the anode plate 2 has a hydrogen inlet manifold chamber 20 at one end and a hydrogen outlet manifold chamber 30 at the other end. Hydrogen gas flows into the cathode channels 121 via the hydrogen inlet manifold chamber 20, and the excess hydrogen gas flows out of the anode channels 221 and enters the hydrogen outlet manifold chamber 30.

As can be seen from FIG. 1, the hydrogen inlet manifold chamber 20 and the hydrogen outlet manifold chamber 30 are disposed at two ends of the anode plate 2; the oxygen inlet manifold chamber 40 and the oxygen outlet manifold chamber 50 are disposed at two ends of the cathode plate 1; and an included angle between a line connecting the hydrogen inlet manifold chamber 20 and the hydrogen outlet manifold chamber 30 and a line connecting the oxygen inlet manifold chamber 40 and the oxygen outlet manifold chamber 50 ranges from 60° to 120°, and preferably 90°. That is, the line connecting the hydrogen inlet manifold chamber 20 and the hydrogen outlet manifold chamber 30 may be perpendicular to the line connecting the oxygen inlet manifold chamber 40 and the oxygen outlet manifold chamber 50. The hydrogen inlet manifold chamber 20, the hydrogen outlet manifold chamber 30, the oxygen inlet manifold chamber 40, and the oxygen outlet manifold chamber 50 are separately arranged, to favorably reduce the complexity of the fluid distribution transition regions (i.e., the respective manifold chambers). Further, it can advantageously solve the problem caused by the fact that the fluid distribution transition regions can hardly be arranged when the scale of the single cells is increased by using the ultrathin cathode plate 1 and the ultrathin anode plate 2, which is conducive to enhancing the power density of the fuel cell.

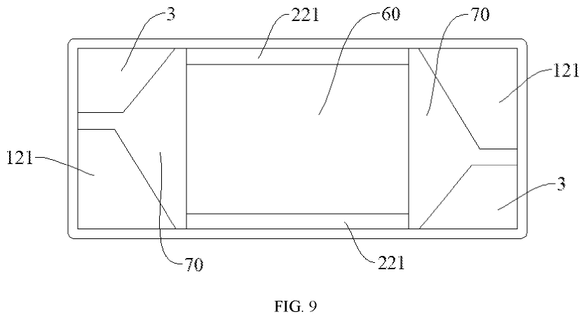

As illustrated in FIG. 9, in a reaction region 60, the oxygen in the cathode channels 121 reacts with the hydrogen in the anode channels 221, the cooling liquid flows in the cooling channels 3, and there is a transition region 70 in the fuel cell to buffer the oxygen in the cathode channels 121 and the hydrogen in the anode channels 221, which is conducive to the sufficient reaction between the hydrogen and the oxygen.

The above are merely the preferred embodiments of the present disclosure and should not be regarded as limitations of the present disclosure. Without departing from the spirit and scope of the present disclosure, any modifications, equivalents, improvements, etc. shall fall within the scope of the present disclosure.

What is claimed is:

1. A fuel cell, comprising at least two single cells stacked adjacent to each other, a cathode plate (1) of one of the at least two single cells being stacked adjacent to an anode plate (2) of an adjacent single cell, wherein
the cathode plate (1) comprises a cathode plate body (11), the cathode plate body (11) has a cathode channel ridge (12) disposed thereon and protruding towards the anode plate (2), and the cathode channel ridge (12) has a cathode channel (121) formed therein;
the anode plate (2) comprises an anode plate body (21), the anode plate body (21) has an anode channel ridge (22) disposed thereon and protruding towards the cathode plate (1), and the anode channel ridge (22) has an anode channel (221) formed therein;
a cooling channel (3) is formed between the cathode plate (1) and the anode plate (2); and
the anode channel ridge (22) and the cathode channel ridge (12) are intersected with each other.

2. The fuel cell according to claim 1, wherein an included angle between the anode channel ridge (22) and the cathode channel ridge (12) ranges from 60° to 120°.

3. The fuel cell according to claim 1, wherein the anode channel ridge (22) is perpendicular to the cathode channel ridge (12).

4. The fuel cell according to claim 1, wherein a recess (122) is formed at an intersection between the anode channel ridge (22) and the cathode channel ridge (12), the anode channel ridge (22) is fitted in the recess (122), the recess (122) is located on a flow path of the cathode channel (121) and is recessed towards an inside of the cathode channel (121), and a channel depth of the cathode channel (121) at the recess (122) is smaller than a channel depth of the cathode channel (121) at a position other than the recess (122).

5. The fuel cell according to claim 4, wherein the channel depth of the cathode channel (121) at the recess (122) is 0.2 mm, and the channel depth of the cathode channel (121) at the position other than the recess (122) is 0.4 mm.

6. The fuel cell according to claim 1, wherein a plurality of anode channel ridges (22) is provided, and the plurality of anode channel ridges (22) is arranged in parallel and spaced apart from each other; and
a plurality of cathode channel ridges (12) is provided, and the plurality of cathode channel ridges (12) is arranged in parallel and spaced apart from each other.

7. The fuel cell according to claim 1, wherein the anode channel ridge (22) has a plurality of sub-channel ridges (23), each of the plurality of sub-channel ridges (23) has a sub-channel (231) formed therein and in communication with the anode channel (221), and each of the plurality of sub-channel ridges (23) is parallel to the cathode channel ridge (12).

8. The fuel cell according to claim 7, wherein the plurality of sub-channel ridges (23) of one of the plurality of anode channel ridges (22) is arranged alternately with the plurality of sub-channel ridges (23) of an adjacent anode channel ridge (22).

9. The fuel cell according to claim 7, wherein the plurality of sub-channel ridges (23) is located between two adjacent cathode channel ridges (12).

10. The fuel cell according to claim 7, wherein the plurality of sub-channel ridge (23) is spaced apart from the cathode plate body (11) and in communication with the cooling channel (3); and the plurality of cathode channel ridge (12) is attached to the anode plate body (21).

11. The fuel cell according to claim 1, wherein the cathode plate (1) is an oxygen-side plate, and the anode plate (2) is a hydrogen-side plate.

12. A fuel cell, comprising at least two single cells stacked adjacent to each other, a cathode plate (1) of one of the at least two single cells being stacked adjacent to an anode plate (2) of an adjacent single cell, wherein
the cathode plate (1) comprises a cathode plate body (11), the cathode plate body (11) has a cathode channel ridge (12) disposed thereon and protruding towards the anode plate (2), and the cathode channel ridge (12) has a cathode channel (121) formed therein;
the anode plate (2) comprises an anode plate body (21), the anode plate body (21) has an anode channel ridge (22) disposed thereon and protruding towards the cathode plate (1), and the anode channel ridge (22) has an anode channel (221) formed therein;
a cooling channel (3) is formed between the cathode plate (1) and the anode plate (2);
the anode channel ridge (22) has a plurality of sub-channel ridges (23), wherein each of the plurality of sub-channel ridges (23) has a sub-channel (231) formed therein and is in communication with the anode channel (221), each of the plurality of sub-channel ridges (23) being parallel to the cathode channel ridge (12), and wherein the plurality of sub-channel ridge (23) is spaced apart from the cathode plate body (11) and in communication with the cooling channel (3); and
the cathode channel ridge (12) is attached to the anode plate body (21).
